(19) United States
(12) Patent Application Publication
(10) Pub. No.: US 2005/0288396 A1
(43) Pub. Date: Dec. 29, 2005

(54) Epoxy resin compositions

(75) Inventors: Hisashi Katayama, Chiba (JP); Takeshi Ichida, Chiba (JP); Hiroyuki Takahashi, Chiba (JP); Masaru Anzai, Chiba (JP)

Correspondence Address: RADER FISHMAN & GRAUER PLLC, LION BUILDING, 1233 20TH STREET N.W., SUITE 501, WASHINGTON, DC, 20036, US

(73) Assignee: NIPPON STEEL CHEMICAL CO., LTD.

(21) Appl. No.: 11/154,540

(22) Filed: Jun. 17, 2005

(30) Foreign Application Priority Data
Jun. 28, 2004 (JP) 2004-189681

(51) Int. Cl. C08K 3/20

(52) U.S. Cl. 523/412

(57) ABSTRACT

This invention relates to a liquid epoxy resin composition which shows excellent adhesiveness, low content of ionic contaminants and good storage stability and is particularly suitable as a material for flip chip packaging and adhesion of substrates. The composition comprises epoxy resin (A) which is liquid at normal temperatures and comprises epoxy resin (A1) represented by the following formula (1) and epoxy resin (A2) having two or more glycidyl ether groups in the molecule, hardeners (B) selected from one kind or more of curing agents and curing catalysts as main ingredients and 0.1-5 wt % of solvent (C) and the content of epoxy resin (A1) in epoxy resin (A) is in the range of 5-75 wt %; at least one of the groups R₁-R₅ in formula (1) is a group represented by the following general formula (2) and the remainder is hydrocarbon groups containing 1-6 carbon atoms or hydrogen atoms.

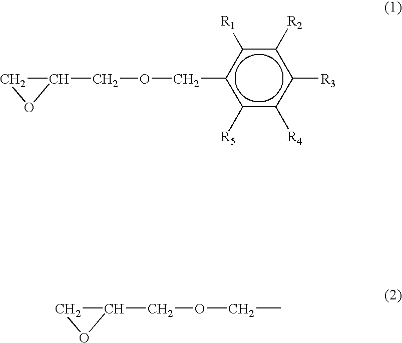

### TECHNICAL FIELD

This invention relates to epoxy resin compositions suitable for electronic applications in packaging of semiconductors and as adhesives and liquid encapsulants.

### BACKGROUND TECHNOLOGY

Materials containing epoxy resins are widely used as resins for encapsulating semiconductors. As the scale of integration of semiconductor devices becomes larger in recent years, there is a growing demand for devices of a type utilizing flip chip interconnection because they are considered to have potentialities of attaining miniaturization and are capable of high-density packaging. Semiconductor devices manufactured by flip chip interconnection are encapsulated, for example, by bonding a bare chip face down to a substrate through a bump and filling the gap between the chip and the substrate with a liquid resin or by coating a substrate with a resin and then packaging a chip and connecting a bump. Any resin chosen for use here desirably has good flow property because the gap between the chip and the substrate is extremely narrow, approximately 100 μm or less, in the former case and there is a need for pouring between narrow-pitch bumps and forming fillets in the latter. Thus, a resin which is liquid at normal temperatures is effective for encapsulating semiconductor devices interconnected by the flip chip technique.

Keeping pace with an advance of electronic instruments toward further miniaturization and lighter weight in recent years, semiconductor devices are driving toward an increasingly larger scale of integration and higher density while creating a demand for higher performance reliability and better properties than available up to now. Furthermore, there is also a growing demand for miniaturization and lighter weight for devices in the peripheral area of semiconductor devices. For example, connectors are generally used in connecting substrates, but there are cases where adhesives are used for miniaturization and lighter weight. The same level of reliability required for semiconductor devices is demanded for these adhesives and the existing adhesives cannot meet this requirement in some cases.

Semiconductor devices are required to provide the kind of reliability that can be assessed by the pressure cooker test (PCT). It sometimes occurs that the reliability of semiconductors manufactured using flip chip interconnection may decrease as a result of peeling of the encapsulating resin off the chip or substrate or migration of ionic impurities in the course of the pressure cooker test. For this reason, encapsulating resins are required to have high adhesiveness, low content of ionic contaminants, good moisture and heat resistance and the like and there is a limit to the performance of ordinary liquid epoxy resins. For example, JP5-218222A gives a description of the use of epoxy resins in flip chip packaging thereby citing only ordinary epoxy resins.

JP11-29624A discloses epoxy resin compositions with improved heat and moisture resistance for encapsulating semiconductors formulated from bisphenol F diglycidyl ether as a main ingredient, naphthalene-based diglycidyl ether and an acid anhydride curing agent.

Moreover, JP4-53821A and JP2004-83711A disclose liquid epoxy resin compositions based on xylylene glycol diglycidyl ether, but they do not show satisfactory improvement in adhesiveness, heat resistance and moisture resistance.

### SUMMARY OF THE INVENTION

An object of this invention is to provide liquid epoxy resin compositions which are suitable for use as materials in flip chip packaging and adhesion of substrates and possess excellent adhesiveness, heat resistance, moisture resistance and the like.

The inventors of this invention have conducted extensive studies to solve the aforementioned problems, found that a combination of specified several kinds of epoxy resins, curing agents and additives can solve the problems and completed this invention.

This invention relates to a liquid epoxy resin composition comprising mainly liquid epoxy resin (A) which is liquid at normal temperatures and contains epoxy resin (A1) represented by the following formula (1) and epoxy resin (A2) having two or more glycidyl ether groups in the molecule and hardeners (B) selected from one kind or more of curing agents and curing catalysts wherein said composition contains 0.1-5 wt % of solvent (C) and the proportion of epoxy resin (A1) in liquid epoxy resin (A) is in the range of 5-75 wt %. 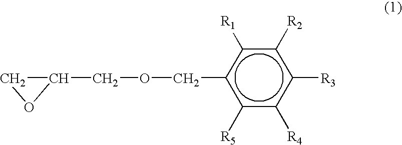
wherein, R₁-R₅ are hydrogen atoms, hydrocarbon groups containing 1-6 carbon atoms or groups represented by the following formula (2) and at least one of R₁-R₅ is the group represented by formula (2).

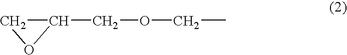

This composition gives a more desirable epoxy resin composition by satisfying one or more of the following conditions: 1) the total chlorine content in liquid epoxy resin (A) is kept below 900 ppm; 2) the composition is made to contain 30-98 wt % of liquid epoxy resin (A), 1-70 wt % of hardeners (B) and 0.1-5 wt % of solvent (C); 3) the composition is made to contain 0.01-3 wt % of surfactants and/or 0.01-3 wt % of silane coupling agents; and 4) any of the foregoing liquid epoxy resin compositions is made to contain 10-300 parts by weight of spherical silica with an average particle diameter of 30 μm or less per 100 parts by weight of the composition. The resulting epoxy resin compositions are useful for flip chip packaging or adhesion of substrates. Furthermore, this invention provides the products obtained by curing the aforementioned epoxy resin compositions.

This invention will be described further below.

A liquid epoxy resin composition of this invention comprises epoxy resin (A) which is liquid at normal temperatures and contains epoxy resin (A1) and epoxy resin (A2), hardeners (B) and solvent (C) as indispensable ingredients. Epoxy resin (A) and hardeners (B) are predominant among these indispensable ingredients. Surfactants, silane coupling agents and the like may be contained in small amounts as optional ingredients.

An epoxy resin composition in which spherical silica is incorporated preferably shows good fluidity and is a liquid or slurry at normal temperatures. Fillers other than spherical silica and other additives may be incorporated in small amounts as optional ingredients. A liquid epoxy resin composition of this invention is preferably liquid, but it may not be liquid in case spherical silica or other solid is incorporated in large amounts.

Epoxy resin (A1) is represented by the formula (1) and one or more, preferably one or two, of R₁-R₅ are the groups represented by the formula (2) and the remainder is hydrocarbon groups containing 1-6 carbon atoms or hydrogen atoms. The hydrocarbon groups are exemplified by methyl, ethyl, isopropyl, tert-butyl and phenyl.

Epoxy resin (A2) containing two or more glycidyl ether groups in the molecule is exemplified by glycidyl ethers derived from naphthalenediols represented by 1,5-naphthalenediol, 1,6-naphthalenediol, 2,7-naphthalenediol and other isomers, dihydric phenols such as bisphenol A, bisphenol F, bisphenol AD, bisphenol S, fluorenebisphenol, 4,4′-biphenol, 2,2′-biphenol, hydroquinone and resorcin, trihydric and higher phenols such as naphthalenetriol isomers, tris(4-hydroxyphenyl)methane, 1,1,2,2-tetrakis(4-hydroxyphenyl)ethane, phenol novolak and o-cresol novolak and halogenated bisphenols such as tetrabromobisphenol. Aliphatic epoxy resin derivatives and alicyclic epoxy resin derivatives can also be used.

Epoxy resin (A2) may be used singly or as a mixture of two kinds or more and it is preferably liquid at normal temperatures. That is, epoxy resin (A2) may be formulated by mixing a solid epoxy resin as one of the ingredients, but the resulting mixture is desirably liquid at normal temperatures.

According to this invention, epoxy resin (A1) and epoxy resin (A2) are used together to form epoxy resin (A) and it is necessary for the mixture to be liquid at normal temperatures. Here, one of epoxy resin (A1) or epoxy resin (A2) may be solid or one or more of plural epoxy resins constituting epoxy resin (A1) or epoxy resin (A2) may be solid as long as the resulting epoxy resin (A) is liquid. In this case, however, the solid epoxy resins preferably account for 70 wt % or less of epoxy resin (A). The content of epoxy resin (A1) in epoxy resin (A) is preferably in the range of 5-75 wt % from the viewpoint of improving the heat resistance and adhesiveness. When the content of epoxy resin (A1) is short of 5 wt %, epoxy resin (A1) which has a relatively low molecular weight does not infiltrate minute uneven places existing on an adherend such as a substrate or the surface micro-roughened by the solvent and, as a result, the effect of improving the adhesiveness is not sufficiently produced. On the other hand, when the content of epoxy resin (A1) exceeds 75 wt %, the heat resistance of the resulting resin composition becomes a problem. It is allowable to incorporate an epoxy resin having only one glycidyl group as an ingredient of epoxy resin (A) in such an amount as not to damage the effect of this invention.

It is desirable that the total chlorine content in liquid epoxy resin (A) is 900 ppm or less. Ionic impurities in epoxy resin compositions are mainly responsible for lowering the reliability of semiconductors after packaging (ion migration) and reduction of the content of chlorine ions is particularly desirable. An epoxy resin composition with a high chlorine content is not affected appreciably in its gel time, but the curing tends to proceed not uniformly and the cured product shows poor mechanical properties. It is desirable to keep the content of total chlorine including ionic chlorine and bound chlorine as low as possible and, in case the composition in question is a grade for encapsulating semiconductors, it is desirable to keep the total chlorine content at 900 ppm or less, preferably at 500 ppm or less.

A liquid epoxy resin composition of this invention comprises hardeners (B) selected from one or more kinds of curing agents and curing catalysts. Hardeners (B) include those which are generally used for epoxy resins, for example, acid anhydrides, phenols, amines, imidazoles, latent curing agents and latent curing catalysts. These curing agents and curing catalysts are preferably soluble in liquid epoxy resin (A), but they may be used in solid form if finely ground.

The acid anhydrides include tetrahydrophthalic anhydride, hexahydrophthalic anhydride, endomethylenetetrahydrophthalic anhydride and its derivatives having substitutents on the hydrocarbon ring, phthalic anhydride and its derivatives having substituents on the benzene ring, succinic anhydride and its derivatives having substituents on the hydrocarbon chain, methylhimic anhydride, nadic anhydride and trimellitic anhydride.

The phenols include dihydric phenols such as bisphenol A, bisphenol F, bisphenol S, fluorenebisphenol, 4,4′-biphenol, 2,2′-biphenol, hydroquinone, resorcin and naphthalenediol, trihydric and higher phenols such as tris(4-hydroxyphenyl)methane, 1,1,2,2-tetrakis(4-hydroxyphenyl)ethane, phenol novolak, o-cresol novolak, naphthol novolak and polyvinyl phenol and polyhydric phenols synthesized from phenols, naphthols or dihydric phenols such as bisphenol A, bisphenol F, bisphenol S, fluorenebisphenol, 4,4′-biphenol, 2,2′-biphenol, hydroquinone, resorcin and naphthalenediol and a condensing agent such as formaldehyde, acetaldehyde, benzaldehyde, p-hydroxybenzaldehyde and p-xylylene glycol.

The amines include aromatic amines such as 4,4′-diaminodiphenylmethane, 4,4′-diaminodiphenylpropane, 4,4′-diaminodiphenyl sulfone, m-phenylenediamine and p-xylylenediamine, aliphatic amines such as ethylenediamine, hexamethylenediamine, diethylenetriamine and triethylenetetramine and dicyandiamide. The imidazoles include 2-methylimidazole, 4-methylimidazole, 2-ethyl-4-methylimidazole, 2,4-dimethylimidazole and 2-phenylimidazole.

The latent curing agents and latent curing catalysts include those of microcapsule type which are prepared by finely grinding the curing agents or catalysts to an average particle diameter of 2-15 μm and encapsulating with polyurethane or acrylic polymer and exhibit good storage stability at normal temperatures and those of amine adduct type. Other curing agents include phosphines and Lewis acids.

Of the aforementioned hardeners (B), the latent curing agents and latent curing catalysts maintain the stability of epoxy resin compositions in the low temperature range during storage and packaging, manifest rapid cure during curing and are effective for realizing good workability in the packaging step of semiconductor devices and wiring substrates. Latent curing agents and latent curing catalysts of microcapsule type are used preferably in this invention from the viewpoint of workability in packaging and stability.

In the use of hardeners (B) according to this invention, it is possible to use one kind or use two kinds or more together. However, it is better to keep the content of the acid anhydrides in hardeners (B) below 70 wt %, preferably below 50 wt %, as the acid anhydrides lower the moisture resistance and storage stability although they are effective for reducing the viscosity of the compositions. In liquid epoxy resin compositions of this invention, the content of hardeners (B) or the total content of curing agents and curing catalysts is preferably in the range of 1-140 parts by weight per 100 parts by weight of epoxy resin (A).

Solvent (C) is added in an amount of 0.1-5% to a liquid epoxy resin composition of this invention. As for the selection of solvent (C), it is preferable to select a solvent which has a boiling point lower than the curing temperature of the resin composition to be used for the manufacture of a semiconductor device or a solvent which shows solubility in an adherend such as a substrate or is close to an adherend in solubility parameter. The selected solvent is acceptable if it is soluble in or compatible with the resin ingredients mainly consisting of epoxy resins. However, when the solvent has a boiling point higher than the curing temperature of the resin composition, there is the possibility of the solvent remaining in the semiconductor device thereby lowering reliability. Therefore, it is better to keep the boiling point at 280° cor below, preferably in the range of 100-250° C. The solubility parameter varies with the adherend and it is preferably in the range of 7-14 cal/mol in case the adherend contains organic matters such as polyimides and epoxy resins as ingredients. Addition of the solvent in an amount short of 0.1 wt % does not satisfactorily produce the effect of improving the adhesiveness in some cases while excessive addition tends to deteriorate the storage stability. Hence, it is preferable to use the solvent while controlling its amount in the range of 0.1-5 wt %.

Concretely, solvent (C) is selected from pyrrolidones, lactones, furans, formamide and its derivatives, acetamide and its derivatives, sulfoxides, glymes, cellosolves, glycol ethers and oxanes and is used either singly or as a mixture of two kinds or more.

It is allowable to add 0.01-3 wt % of surfactants and/or 0.01-3 wt % of silane coupling agents to liquid epoxy resin compositions of this invention if necessary.

The surfactants contribute to improve the adhesive strength by improving the wettability of the adherend. Of anionic, cationic, nonionic and amphoteric surfactants, nonionic surfactants are suitable for use in this invention and they can be used singly or as a mixture of two kinds or more. It is desirable that the surfactants are soluble in liquid epoxy resins.

The coupling agents contribute to improve the adhesiveness to the silicon chip and the moisture resistance. Preferred coupling agents are γ-glycidoxypropyltrimethoxysilane and its derivatives. It is desirable that the coupling agents are soluble in liquid epoxy resins.

When the aforementioned liquid epoxy resin composition is used in a specified application, particularly as a flip chip packaging material to a hard substrate represented by FR-4, it is desirable to have the composition contain fillers. Fillers useful for this purpose include silica powder such as spherical or ground fused silica and crystalline silica, alumina powder, glass powder and metal powder. Of these fillers, spherical silica is most preferable. In this case, the average particle diameter is kept below 30 μm, preferably below 20 μm. The amount of the filler is 10-300 parts by weight, preferably 50-200 parts by weight, per 100 parts by weight of the liquid epoxy resin composition exclusive of the filler.

It is allowable, if necessary, to incorporate colorants such as carbon black, flame retardants such as halogen-containing compounds and antimony trioxide, stress-reducing agents such as silicone oil and acrylic rubber, lubricants such as calcium stearate and conductive particles in filled epoxy resin compositions of this invention.

The conductive particles include particles of metals such as Au, Ag, Cu, Ni, W and solder, metal particles the surface of which is coated with a thin film of Au, Pd or the like by vacuum deposition or plating and particles consisting of polystyrene or polydivinylbenzene nuclei and a conductive layer of Au, Cu, Ni or solder.

A liquid epoxy resin composition of this invention comprises the aforementioned liquid epoxy resin (A), hardeners (B) and solvent (C) as indispensable ingredients and the contents of respective ingredients are as follows.
Liquid epoxy resin (A); 30-98 wt %, preferably 55-94 wt %.
Hardeners (B); 1-70 wt %, preferably 5-45 wt %.
Solvent (C); 0,1-5 wt %, preferably 1-3 wt %.

Liquid epoxy resin compositions of this invention, filled or unfilled, can be used in flip chip packaging or adhesion of substrates by making the most of their low viscosity. Moreover, these compositions yield cured products of this invention by heating or molding under heat.

Resin compositions of this invention show excellent adhesiveness, low content of ionic contaminants and good storage stability. They can be used as materials for flip chip packaging and adhesion of substrates and are capable of improving the reliability of flip chip and have an extremely great industrial value as they can cope with larger scale of integration and higher density of semiconductor devices necessitated by the continuing drive of electronic instruments toward miniaturization and lighter weight.

### EXAMPLES

This invention will be described in detail below with reference to the accompanying examples. Various properties in the examples were evaluated in accordance with the test methods shown below.

Total Chlorine Content (TCl)

The total chlorine content in an epoxy resin was determined by treating the resin thoroughly with a propylene glycol solution of potassium hydroxide taken in excess of chlorine in the resin content and potentiometrically titrating the product potassium chloride with an aqueous solution of silver nitrate.

Contact Angle (CA)

An epoxy resin composition was dropped on a polyimide substrate and the contact angle of the liquid was measured to evaluate the wettability.

Storage Stability (SS)

The viscosity of a resin composition was determined immediately after the preparation and after 10-day storage at 25° C. with an E type viscometer at 5 rpm and the storage stability was evaluated on the basis of the increase in viscosity. The numerical values of SS in Tables 1 and 2 denote the calculated values of [(viscosity after 10 days)/(viscosity immediately after preparation)]×100.

Adhesiveness (AD)

An adherend was coated with a resin composition, a chip measuring 10 mm×1 mm provided with bumps with a height of approximately 30 μm at the corners was placed on the coated adherend, the assembly was cured at 200° C. for 30 minutes and the adhesive strength (90° peel strength) was measured. ADPI denotes the adhesiveness to the polyimide substrate, ADC to the chip and ADFR to FR-4.

Glass Transition Temperature (Tg) and Coefficient of Thermal Expansion (CTE)

A resin composition was cured at 200° C. for 30 minutes and a specimen prepared from the cured composition, 10 mm in length, was mounted on a TMA to measure the glass transition temperature (Tg) and the coefficient of thermal expansion (CTE) below and above Tg. CTE1 denotes CTE at <Tg while CTE2 denotes CTE at >Tg.

Flexural Strength (FS) and Flexural Modulus (FM)

A resin composition was cured at 200° C. for 30 minutes to prepare a test specimen measuring 100 mm ×10 mm×4 mm and the specimen was submitted to the three-point bending test at a span of 64 mm to determine the flexural strength and flexural modulus.

Pressure Cooker Test (PCT)

The thermal shock resistance was evaluated by coating a polyimide substrate with an epoxy resin composition, performing flip chip packaging and bump interconnection, submitting the resulting flip chip package to the pressure cooker test in an atmosphere of saturated water vapor at 121° C. and two atmospheres and examining the reject rate or the ratio of the number of rejects to the number of specimens tested.

The compounds used in the examples are abbreviated as follows.
PXGDG: p-Xylylene glycol diglycidyl ether
BPAG: Bisphenol A diglycidyl ether
BPFG: Bisphenol F diglycidyl ether
MCMI: 2-Methylimidazole (in micro-capsules as latent curing agent)
NMP: N-Methylpyrrolidone
NDAM: N,N-Dimethylacetamide
DEGDME: Diethylene glycol dimethyl ether
NS: Nonionic surfactant
SC: Silane coupling agent
SiO₂: Spherical silica
PI: Polyimide

### Examples 1-2

A liquid epoxy resin composition was formulated from liquid PXGDG as epoxy resin (A1), a mixture of liquid BPAG and liquid BPFG as epoxy resin (A2), MCMI or 2-methylimidazole finely ground to a diameter of 5 μm and micro-encapsulated with polyurethane as hardener (B) and NMP as solvent (C) as shown in Table 1 (on a weight basis). On visual observation, the liquid epoxy resin composition obtained in this manner exhibited such a degree of fluidity as to change in shape at the time of flip chip packaging. This composition was molded at 200° C. for 30 minutes to give a specimen of cured product, which was tested for various properties.

### Comparative Examples 1-3

Liquid epoxy resin compositions were formulated, molded and evaluated as in Examples 1 and 2 while varying the amounts of ingredients as shown in Table 1.

### Example 3 and Comparative Examples 4-6

Liquid epoxy resin compositions were formulated, molded and evaluated as in Examples 1 and 2 while varying the amount of solvent (C) as shown in Table 1.

The results are shown in Table 1.

TABLE 1

| | Example | | | Comparative Example | | | | | |
|---|---|---|---|---|---|---|---|---|---|
| | 1 | 2 | 3 | 1 | 2 | 3 | 4 | 5 | 6 |
| PXGDG | 40 | 20 | 20 | 60 | 3 | | 20 | 20 | 20 |
| BPAG | 7 | 11 | 11 | 3 | 14 | 15 | 11 | 11 | 11 |
| BPFG | 28 | 44 | 44 | 12 | 58 | 60 | 44 | 44 | 44 |
| MCMI | 25 | 25 | 25 | 25 | 25 | 25 | 25 | 25 | 25 |
| NMP | 1 | 1 | 3 | 1 | 1 | 1 | 6 | 0.01 | |
| TCI (ppm) | 540 | 570 | 570 | 500 | 590 | 600 | 560 | 570 | 570 |
| CA (°) | 43 | 45 | 45 | 44 | 47 | 47 | 46 | 44 | 45 |
| SS (%) | 104 | 107 | 109 | 99 | 110 | 140 | 155 | 103 | 103 |
| ADPI (g/mm²) | 890 | 890 | 910 | 920 | 580 | 430 | 930 | 610 | 600 |
| Tg (° C.) | 105 | 107 | 107 | 94 | 118 | 119 | 106 | 107 | 108 |
| CTE1(×10⁻⁵) | 6.2 | 6.1 | 6.1 | 7.0 | 5.9 | 6.0 | 6.1 | 6.0 | 6.1 |
| CTE2(×10⁻⁵) | 20.4 | 20.5 | 20.6 | 22.6 | 20.2 | 20.1 | 20.9 | 20.5 | 20.5 |
| FS (MPa) | 150 | 150 | 150 | 150 | 160 | 160 | 140 | 150 | 150 |
| FM (MPa) | 3550 | 3620 | 3660 | 3510 | 3630 | 3690 | 3550 | 3600 | 3640 |
| PCT 50 hr | 0/10 | 0/10 | 0/10 | 0/10 | 0/10 | 0/10 | 0/10 | 0/10 | 0/10 |
| 100 hr | 0/10 | 0/10 | 0/10 | 0/10 | 0/10 | 0/10 | 0/10 | 0/10 | 0/10 |
| 150 hr | 0/10 | 0/10 | 0/10 | 0/10 | 0/10 | 1/10 | 0/10 | 0/10 | 0/10 |
| 200 hr | 0/10 | 0/10 | 0/10 | 1/10 | 1/10 | 2/10 | 1/10 | 0/10 | 0/10 |
| 250 hr | 0/10 | 0/10 | 0/10 | 2/10 | 2/10 | 4/10 | 2/10 | 0/10 | 0/10 |
| 300 hr | 0/10 | 1/10 | 1/10 | 4/10 | 5/10 | 6/10 | 4/10 | 1/10 | 1/10 |

### Examples 4-6

Liquid epoxy resin compositions were formulated, molded and evaluated as in Examples 1 and 2 while varying the amount of solvent (C) as shown in Table 2.

### Examples 7-8

Liquid epoxy resin compositions were formulated, molded and evaluated as in Examples 1 and 2 while adding the surfactant as shown in Table 2.

### Examples 9-10

Liquid epoxy resin compositions were formulated, molded and evaluated as in Examples 1 and 2 while adding the silane coupling agent as shown in Table 2.

### Examples 10-12

Liquid epoxy resin compositions were formulated, molded and evaluated as in Examples 1 and 2 while adding the spherical silica as shown in Table 2.

The results are shown in Table 2.

TABLE 2

| | Example No. | | | | | | | | |
|---|---|---|---|---|---|---|---|---|---|
| | 4 | 5 | 6 | 7 | 8 | 9 | 10 | 11 | 12 |
| PXGDG | 20 | 20 | 20 | 20 | 20 | 20 | 20 | 20 | 20 |
| BPAG | 11 | 11 | 11 | 11 | 11 | 11 | 11 | 11 | 11 |
| BPFG | 44 | 44 | 44 | 44 | 44 | 44 | 44 | 44 | 44 |
| MCMI | 25 | 25 | 25 | 25 | 25 | 25 | 25 | 25 | 25 |
| DEGDGE | 1 | | | | | | | | |
| NMP | | 1 | | 1 | 1 | 1 | 1 | 1 | 1 |
| EGME | | | 1 | | | | | | |
| NS | | | | 1 | 0.01 | | | | |
| SC | | | | | | 1 | 0.01 | | |
| SiO₂ | | | | | | | | 200 | 50 |
| TCl (ppm) | 560 | 560 | 570 | 570 | 570 | 570 | 570 | 190 | 380 |
| CA (°) | 40 | 41 | 42 | 24 | 31 | 43 | 43 | 51 | 48 |
| SS (%) | 104 | 101 | 102 | 107 | 106 | 109 | 108 | 112 | 110 |
| ADPI (g/mm²) | 810 | 790 | 740 | 980 | 960 | 980 | 950 | | |
| ADC (g/mm²) | | | | | | 780 | 770 | | |
| ADFR (g/mm²) | | | | | | | | 680 | 700 |
| Tg (° C.) | 106 | 107 | 107 | 107 | 107 | 108 | 107 | 112 | 110 |
| CTE1(×10⁻⁵) | 6.1 | 6.1 | 6.2 | 6.1 | 6.1 | 6.0 | 6.1 | 2.1 | 4.1 |
| CTE2(×10⁻⁵) | 20.5 | 20.7 | 20.5 | 20.5 | 20.4 | 20.5 | 20.6 | 6.9 | 13.5 |
| FS (MPa) | 150 | 150 | 150 | 150 | 150 | 150 | 160 | 160 | 160 |
| FM (MPa) | 3600 | 3580 | 3610 | 3590 | 3600 | 3690 | 3640 | 9590 | 6100 |
| PCT 50 hr | 0/10 | 0/10 | 0/10 | 0/10 | 0/10 | 0/10 | 0/10 | 0/10 | 0/10 |
| 100 hr | 0/10 | 0/10 | 0/10 | 0/10 | 0/10 | 0/10 | 0/10 | 0/10 | 0/10 |
| 150 hr | 0/10 | 0/10 | 0/10 | 0/10 | 0/10 | 0/10 | 0/10 | 0/10 | 0/10 |
| 200 hr | 0/10 | 0/10 | 0/10 | 0/10 | 0/10 | 0/10 | 0/10 | 0/10 | 0/10 |
| 250 hr | 0/10 | 0/10 | 0/10 | 0/10 | 0/10 | 0/10 | 0/10 | 0/10 | 0/10 |
| 300 hr | 0/10 | 0/10 | 0/10 | 0/10 | 0/10 | 0/10 | 0/10 | 0/10 | 0/10 |

A flip chip was prepared by thermocompression bonding of a substrate to a chip using each of the liquid epoxy resin compositions obtained in Examples 1-12. Any of the flip chips thus prepared formed a good fillet and no void was observed in the resin layer underneath the chip.

1. An epoxy resin composition comprising mainly liquid epoxy resin (A) which is liquid at normal temperatures and comprises epoxy resin (A1) represented by the following formula (1) 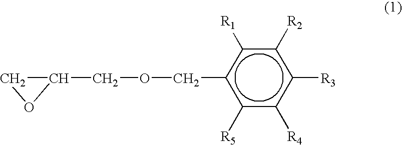
wherein, R₁-R₅ are hydrogen atoms, hydrocarbon groups containing 1-6 carbon atoms or groups represented by the following formula (2) and at least one of R₁-R₅ is the group represented by formula (2) 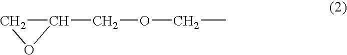
and epoxy resin (A2) having two or more glycidyl ether groups in the molecule and hardeners (B) selected from one kind or more of curing agents and curing catalysts wherein said composition contains 0.1-5 wt % of solvent (C) and the proportion of epoxy resin (A1) in liquid epoxy resin (A) is in the range of 5-75 wt %.

2. An epoxy resin composition as described in claim 1 wherein the total chlorine content in liquid epoxy resin (A) is 900 ppm or less.

3. An epoxy resin composition as described in claim 1 wherein the composition comprises 30-98 wt % of liquid epoxy resin (A), 1-70 wt % of hardeners (B) and 0.1-5 wt % of solvent (C).

4. An epoxy resin composition as described in claim 1 wherein the composition comprises 0.01-3 wt % of surfactants and/or 0.01-3 wt % of silane coupling agents.

5. An epoxy resin composition comprising 100 parts by weight of the epoxy resin composition described in claim 1 and 10-300 parts by weight of spherical silica with an average particle diameter of 30 μm or less.

6. An epoxy resin composition as described in claim 1 for use in flip chip packaging or adhesion of substrates.

7. An epoxy resin composition as described in claim 5 for use in flip chip packaging or adhesion of substrates.

8. A product obtained by curing the epoxy resin composition described in claim 1.
